(19) United States
(12) Patent Application Publication
(10) Pub. No.: US 2012/0125649 A1
(43) Pub. Date: May 24, 2012

(54) Hand-Held Machine Tool

(76) Inventors: Oliver Ohlendorf, Landsberg (DE); Jorg Martin, Obermeitingen (DE)

(21) Appl. No.: 13/294,775

(22) Filed: Nov. 11, 2011

(30) Foreign Application Priority Data
Nov. 12, 2010 (DE) 102010043810.3

(51) Int. Cl. B25D 17/24; B25F 5/00

(52) U.S. Cl. 173/162.2

(57) ABSTRACT

A hand-held machine tool having a linear drive for moving a tool along a working axis, e.g. a motor-driven pneumatic driving tool, is provided. At least two dampers are provided in the hand-held machine tool for damping vibrations along the working axis. A resonant excitation of a vibration of the first damper along the working axis occurs at a first resonance frequency, which differs from a second resonance frequency of the second damper for the vibration along the working axis.

### RELATED APPLICATIONS

The present application claims priority to German Patent Application DE 10 2010 043 810.3, filed Nov. 12, 2010, and entitled “Handwerkzeugmaschine” (“Hand-Held Machine Tool”), the entire content of which is incorporated herein by reference.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a hand-held machine tool with a damper.

### BRIEF SUMMARY OF THE INVENTION

A hand-held machine tool according to aspects of the present invention has a linear drive for moving a tool along a working axis, e.g. a motor-driven, pneumatic striking tool. At least two dampers are provided in the hand-held machine tool for damping vibrations along the working axis. A resonant excitation of a vibration of the first damper along the working axis occurs at a first resonance frequency, which differs from a second resonance frequency of the second damper for the vibration along the working axis. The two resonance frequencies may differ in a range of about 2% to 5%, i.e., the first frequency is 1.02 to 1.05 times greater than the second resonance frequency.

One embodiment provides that each of the two dampers has a pendulum arm and an inertial mass. The inertial mass is fastened to a housing of the hand-held machine tool elastically by means of the pendulum arm. The end of the pendulum arm at a distance from the inertial mass forms a bearing point in order to execute a rotary motion by the pendulum arm guided by the inertial mass. The deflection preferably remains small, e.g., less than about 30 degrees around the bearing point, whereby the motion of the inertial mass is approximately perceived as being along the working axis. To counteract a deflection out of the plane of rotation, the pendulum arm or the bearing is designed so it is very stiff, which results in very high resonance frequencies. These high resonance frequencies should be at least on an order of magnitude or ten times higher than the resonance frequencies for an excitation along the working axis in order not to allow excitation.

In certain embodiments, an adaptation of the resonance frequencies of the two dampers can occur using the length of the pendulum arms, which can differ in a range from about 4% to 10%. In this case, the length indicates the distance of the inertial mass center of gravity up to the bearing point on the housing. Alternatively or additionally, the masses of the inertial masses can differ by about 4% to 10%.

One embodiment provides that the pendulum arm of a first of the two dampers is arranged parallel to a pendulum arm of a second of the two dampers. The pendulum arms can be mounted at least about 70 degrees with respect to the working axle. The pendulum arms can be designed as leaf springs. The leaf springs can be connected by a rib at the end at a distance from the inertial masses. In one embodiment, the two leaf springs are produced as stamped parts. The inertial masses can be slipped onto the pendulum arm.

One embodiment provides that a periodicity with which the linear drive moves the tool along the working axis lies between the resonance frequencies of the two dampers. The tool is typically non-harmonic, i.e. not clearly sinusoidal motion. Therefore the term periodicity or repetition rate appears more suitable for indicating how frequently the tool moves back and forth in a time standard. The periodicity, like a frequency, is measured in Hertz. If a frequency is used in the application to describe a non-harmonic motion, this indicates the base frequency.

### BRIEF DESCRIPTION OF SEVERAL VIEWS OF THE DRAWINGS

The following description explains the invention using exemplary embodiments and figures. In the figures,

FIG. 1 shows a hand-held machine tool formed in accordance with an embodiment of the present invention.

FIG. 2 shows a cross section through a damper of FIG. 1.

FIG. 3 shows an excitation spectrum of the damper of FIG. 2.

Elements that are the same or have the same function are indicated with the same reference numbers in the figures, unless otherwise indicated.

### DETAILED DESCRIPTION OF THE INVENTION

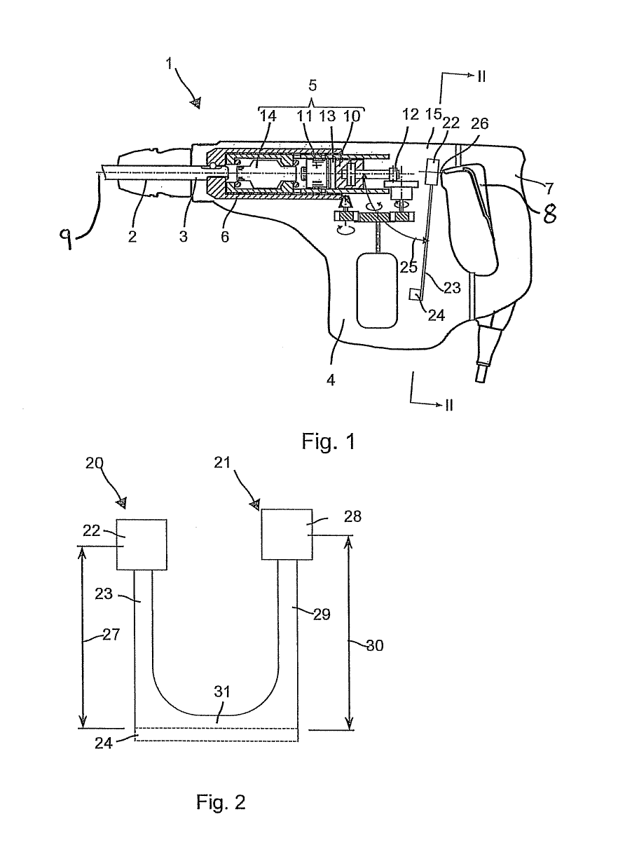

FIG. 1 shows a hammer drill 1 schematically. The hammer drill 1 has a tool holding fixture 2, in which a boring tool 3 can be used. A motor 4 forms a primary drive of the hammer drill 1, which drives a striking tool 5 and an output shaft 6. A user can guide the hammer drill 1 using a handle 7 and put the hammer drill 1 in operation using a system switch 8. In operation, the hammer drill 1 turns the boring tool 3 continuously around a working axis 9 and in this process can drive the boring tool 3 into a substrate along the working axis 9.

The striking tool 5 is, for example, a pneumatic striking tool 5. An exciter 10 and a striker 11 are guided in the striking tool 5 along the working axis 9. The exciter 10 is linked to the motor 4 by a cam 12 or a finger and forced into a periodic linear motion. A pneumatic spring formed by a pneumatic chamber 13 between exciter 10 and striker 11 couples a motion of the striker 11 to the motion of the exciter 10. The striker 11 can strike directly at the back end of the boring tool 3 or transfer part of its pulse to the boring tool 3 by way of an essentially resting intermediate striking 14. The striking tool 5, and preferably the other drive components, is arranged inside a machine housing 15.

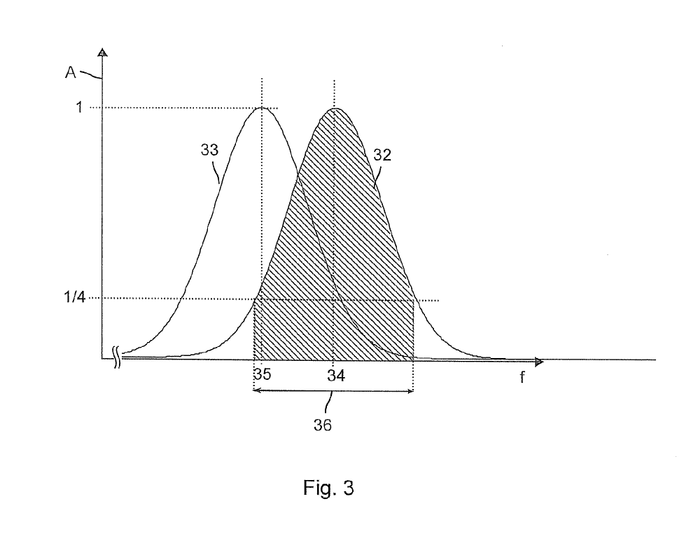

Within the machine housing 15, a first damper 20 and a second damper 21 are mounted. In the side view in FIG. 1, the first damper 20 covers the second damper 21. The cross section in the plane II-II through the two dampers 20, 21 is shown in FIG. 2.

The first damper 20 has a first inertial mass 22 that is connected by way of a leaf spring 23 to a rigid bearing point 24 on the housing 15. The leaf spring 23 is, in rest position, arranged at an angle 25 of at least about 70 degrees with respect to the working axis 9. A motion of the machine housing 15 along the working axis 9 can excite the inertial mass 22 to the same type of motion along the working axis 9. Because of the guide of the inertial mass 22 by the leaf spring 23, the inertial mass 22 follows a curved path 26. The deflections of the inertial mass 22 are small compared to a length 27 of the leaf spring 23, whereby the motion can be assumed to be approximately parallel to the working axis 9. The length 27 of the leaf spring 23 is measured from the fastening 24 to the center of gravity of the first inertial mass 22. By using a restoring force, the leaf spring 23 counteracts a deflection of the inertial mass 22 from its rest position. The restoring spring force, the length 27 of the leaf spring 23 and the mass of the inertial mass 22 determine a resonance frequency of the first damper 20.

The leaf spring 23 has a lower stiffness along the working axis 9 compared to the directions perpendicular to the working axis 9. An excitation of the leaf spring 23 perpendicular to the working axis 9 is thus only possible at very high frequencies.

The second damper 21 is structured generally the same as the first damper 20. A second inertial mass 28 is connected by way of a second leaf spring 29 to the machine housing 15. The second leaf spring 29 is preferably mounted parallel to the first leaf spring 23 and also, in rest position, tipped by at least about 70 degrees with respect to the working axis 9. The two leaf springs 22, 29 preferably have the same spring constant and thickness; in contrast a length 30 of the second leaf spring 29 is about 4% to 10% longer than the length 27 of the first leaf spring 22. A mass of the second inertial mass 28 is approximately the same as the mass of the first inertial mass 22. The different lengths 30, 29 cause an about 2% to 5% lower resonance frequency of the second damper 21. In another embodiment, the inertial masses 22, 28 have masses that are different by about 4% to 10%.

The leaf springs 22, 29 can be produced as stamped sheet metal. The two leaf springs 22, 29 can connect via a bridge 31.

FIG. 3 shows the behavior of the two dampers 20, 21 for various excitation frequencies f; the deflection, standardized to the maximum deflection A (amplitude) of the inertial masses 22, 28 along the working axis 9, is entered over the Y axis. The curve 32 indicates the excitation spectrum for the first damper 20; curve 33 shows the excitation spectrum for the second damper 21.

The two dampers 20, 21 are tuned to each other. The tuning of the resonance frequency 34 of the first damper 20 is greater than the resonance frequency 35 of the second damper 21. An excitation of a damper with frequencies greater than its resonance frequency can lead to a build-up of the damper in the hand-held machine tool 1 and, instead of a desired damping of vibrations causes an increase in the vibrations. This actually contradicts the use of a second damper with another frequency for damping vibrations along working axis 9. However it was found that when the two dampers 20, 21 are only somewhat tuned to each other, these couple with each other and the lower-frequency damper 21 still does not build up if the excitation frequency f through the linear drive 5 lies between the resonance frequencies 35, 34 of the two dampers 20, 21. The resonance frequency 34 of the first damper 20 should lie within a frequency band 36, within which the excitation spectrum 32 of the second damper 21 drops to no more than about one-fourth (shaded area), and preferably to no more than about one-half of the maximum amplitude. The two dampers 20, 21 then couple strongly with each other. In total, a broader resonance results for the entire system of the two dampers 20, 21. The coupling of the two dampers 20, 21 can be further increased by the elastic bridge 31 between the leaf springs 29, 22. The resonance frequencies 34, 35 are preferably adjusted using the pendulum arms 23, 29 and the inertial masses 22, 28 in such a way that a periodicity of the linear drive 5 lies between the resonance frequencies 34, 35.

The dampers 20, 21 can also be used in a compass saw or a saber saw.

1. A hand-held machine tool comprising a linear drive for moving a tool along a working axis, and two dampers with resonance frequencies that differ for a motion along the working axis, wherein the resonance frequency of a first of the two dampers lies within a frequency band within which an excited second of the two dampers vibrates with a deflection that corresponds to at least one-fourth of a deflection during resonant excitation of the second damper.

2. A hand-held machine tool according to claim 1, wherein the resonance frequencies of the dampers differ by at least about 2%.

3. A hand-held machine tool according to claim 1, wherein each of the two dampers includes a pendulum arm and an inertial mass which is elastically fastened by means of the pendulum arm to a housing of the hand-held machine tool.

4. A hand-held machine tool according to claim 3, wherein the lengths of the pendulum arms differ in a range from about 4% to 10%.

5. A hand-held machine tool according to claim 3, wherein the masses of the inertial masses differ in a range from about 4% to 10%.

6. A hand-held machine tool according to claim 3, wherein the pendulum arm of a first of the two dampers is arranged parallel to the pendulum arm of a second of the two dampers.

7. A hand-held machine tool according to claim 3, wherein the pendulum arms are mounted such that they are tilted at least about 70 degrees with respect to the working axis.

8. A hand-held machine tool according to claim 3, wherein the pendulum arms are designed as leaf springs.

9. A hand-held machine tool according to claim 8, wherein the leaf springs are connected by a rib at their ends that is at a distance from the inertial masses.

10. A hand-held machine tool according to claim 1, wherein the resonance frequency for an excitation of the two dampers in a motion perpendicular to the working axis is higher by at least an order of magnitude than the resonance frequency for the motion along the working axis.

11. A hand-held machine tool according to claim 1, wherein the periodicity with which the linear drive moves the tool along the working axis varies between the resonance frequencies of the two dampers.
